(19) United States
(12) Patent Application Publication
(10) Pub. No.: US 2026/0110776 A1
(43) Pub. Date: Apr. 23, 2026

(54) TRANSMISSION COVER FOR LIDAR SENSOR

(71) Applicants: HYUNDAI MOTOR COMPANY, Seoul (KR); KIA CORPORATION, Seoul (KR); ECOPLASTIC CORPORATION, Gyeongju-si (KR)

(72) Inventors: Seon-Yong AN, Hwaseong-si (KR); Kyoung-Chun KWEON, Hwaseong-si (KR); Gyeom-Son SEONG, Gunpo-si (KR); Wan-Ho SON, Gunpo-si (KR); Tai-Won KIM, Gyeongju-si (KR)

(21) Appl. No.: 19/060,277

(22) Filed: Feb. 21, 2025

(30) Foreign Application Priority Data
Oct. 18, 2024 (KR) 10-2024-0142559

(51) Int. Cl. G01S 7/481

(52) U.S. Cl. CPC G01S 7/4813

(57) ABSTRACT

A transmission cover for a light detection and ranging (LiDAR) sensor includes a base layer made of a thermoplastic material and a multilayered film layer bonded to the base layer. The film layer has a metallic color. The transmission cover makes it possible to implement a three-dimensional exterior design by implementing a two-dimensional or three-dimensional shape while maintaining functionality of the sensor using an infrared transmission film.

### CROSS-REFERENCE TO RELATED APPLICATION

This application claims priority to Korean Patent Application No. 10-2024-0142559, filed on Oct. 18, 2024, which is incorporated herein by reference in its entirety.

### TECHNICAL FIELD

The present disclosure relates to a transmission cover for a light detection and ranging (LiDAR) sensor, which is applied to a LiDAR sensor.

### BACKGROUND

Vehicles capable of autonomous driving may include LiDAR units for detecting obstacles and the like near the vehicle.

For instance, a LiDAR sensor detects objects based on light reflected from front objects by emitting infrared light and may be positioned at the front and top of the vehicle.

Covers for a LiDAR sensor have may a simple protection function, and these covers may be made of plastic or glass, for instance.

In some cases, the covers for a LiDAR sensor may not be considered in the design of vehicles due to limitations in technology and manufacturing, and applicable materials are limited, making it difficult to improve performance degradation due to environmental factors.

In some cases, LiDAR covers may be vulnerable to environmental factors such as a change in temperature, humidity, and a physical impact, and may lower long-term performance and reliability.

In addition, the design of the cover may not match the exterior of the vehicle and thus fails to satisfy the design requirements of vehicle manufacturers.

### SUMMARY

The present disclosure describes a method of manufacturing a transmission cover for a light detection and ranging (LiDAR) sensor, which is capable of implementing a three-dimensional exterior design by implementing a two-dimensional or three-dimensional shape while maintaining functionality of the sensor using an infrared transmission film.

According to one aspect of the subject matter described in this application, a transmission cover for a light detection and ranging (LiDAR) sensor includes a base layer made of a thermoplastic material and a film layer that is bonded to the base layer and provides a metallic color, the film layer including a plurality of layers that are stacked.

Implementations according to this aspect can include one or more of the following features. For example, the plurality of layers of the film layer can include a LiDAR-transmitting film that provides the metallic color and is configured to transmit infrared light having a preset wavelength range. In some examples, the LiDAR-transmitting film can be a multi-layered film including polyethylene terephthalate (PET) films that are each thinner than 1 μm.

In some examples, the plurality of layers of the film layer can further include an infrared (IR) printing layer that is stacked on the LiDAR-transmitting film, the IR printing layer having a preset pattern. In some examples, the plurality of layers of the film layer can further include a binder layer that is interposed between the LiDAR-transmitting film and the IR printing layer and couple the LiDAR-transmitting film and the IR printing layer to each other.

In some implementations, the plurality of layers of the film layer can further include a first polycarbonate (PC) layer that is disposed on a surface of the LiDAR-transmitting film. In some examples, the plurality of layers of the film layer can further include a second PC layer that is disposed on a surface of the IR printing film. In some examples, the plurality of layers of the film layer can further include a binder layer that is disposed on a surface of the first PC layer or a surface of the second PC layer.

In some implementations, the plurality of layers of the film layer can include a polycarbonate (PC) layer that is disposed on a surface of the IR printing film. In some examples, the film layer can further include a polycarbonate (PC) layer that is disposed on a surface of the LiDAR-transmitting film.

In some implementations, the transmission cover can include a protective layer that is made of a polyurethane (PU) material and coated on the film layer. In some examples, the film layer can define a three-dimensional shape.

According to another aspect, a transmission cover for a light detection and ranging (LiDAR) sensor includes a film layer that provides a metallic color and defines a three-dimensional shape having a protrusion or a recess, a base layer made of a thermoplastic material and attached to a first side of the film layer, a protective layer made of polyurethane and attached to a second side of the film layer opposite to the first side. The base layer and the protective layer cover the film layer and have internal shapes corresponding to the three-dimensional shape of the film layer to thereby define an even thickness of the transmission cover.

Implementations according to this aspect can include one or more of the following features. For example, the film layer includes a plurality of layers including one or more upper polycarbonate (PC) layers, one or more infrared (IR) printing layers disposed below and attached to one of the one or more upper PC layers, a binding layer disposed below and attached to the one or more IR printing layers, and a LiDAR-transmitting film disposed below and attached to the binding layer. In some examples, the one or more IR printing layers have a preset pattern, and the LiDAR-transmitting film is a multi-layered film including polyethylene terephthalate (PET) films that are each thinner than 1 μm.

In some examples, the plurality of layers of the film layer can further include a lower PC layer that is disposed below and attached to the LiDAR-transmitting film, the lower PC layer defining a bottom surface of the film layer. In some examples, the plurality of layers of the film layer further include a top binder layer disposed above and attached to the one or more upper PC layers, the top binder layer defining a top surface of the film layer.

In some implementations, the plurality of layers of the film layer can further include a top binder layer disposed above and attached to the one or more upper PC layers, the top binder layer defining a top surface of the film layer, a lower PC layer that is disposed below and attached to the LiDAR-transmitting film, and a bottom binder layer disposed below and attached to the lower PC layer, the bottom binder layer defining a bottom surface of the film layer.

In some implementations, the film layer includes a plurality of layers including a binder layer that defines a top surface of the film layer, an infrared (IR) printing layer below and attached to the binder layer, a LiDAR-transmitting film disposed below and attached to the IR printing layer, and a lower PC layer that is disposed below and attached to the LiDAR-transmitting film, the lower PC layer defining a bottom surface of the film layer.

In related art, where transmission covers for a LiDAR sensor provide LiDAR transmission by simply adopting a transparent material (glass, PC, PET, or the like), the design matching with nearby components may be poor, and it may not be easy to implement various shapes (3D).

The present disclosure describes an integrated LiDAR transmission cover that provides a metallic appearance, LiDAR transmission, and surface self-restoration.

In some implementations, a desired design can be implemented entirely or locally through a printing process, and preforming into a 3D shape is possible due to the use of the film.

In addition, damage to the LiDAR-transmitting film and design printing can be minimized by optimizing the injection process, and the self-restoration function can be applied to prevent a degradation in LiDAR transmission performance due to microscopic surface defects.

For example, when a scratch occurs on the PC layer, the sensing performance of the LiDAR can be reduced by 20% or more, and since the PU material is self-restored, such a problem can be supplemented through front PU and back PC injection in preparation for PC double injection.

### BRIEF DESCRIPTION OF THE DRAWINGS

FIG. 1 schematically illustrates an example of a transmission cover for a LiDAR sensor of the present disclosure.

FIG. 2 schematically illustrates an example of a method for manufacturing a transmission cover for a LiDAR sensor of the present disclosure.

FIG. 3 illustrates a cross-section of the transmission cover.

FIGS. 4 and 5 illustrate examples of the method for manufacturing the transmission cover.

FIGS. 6-11 illustrate examples of a film layer of a transmission cover for a LiDAR sensor.

FIG. 12 illustrates a schematic view of light reflection and a cross-section of a metallic film.

FIG. 13 illustrates test images of samples.

FIG. 14 illustrates intensity measurement results of the samples.

### DETAILED DESCRIPTION

For a full understanding of the present disclosure, operational advantages of the present disclosure, and objects to be achieved by practicing the present disclosure, reference should be made to the accompanying drawings, which illustrate example implementations of the present disclosure, and contents described in the accompanying drawings.

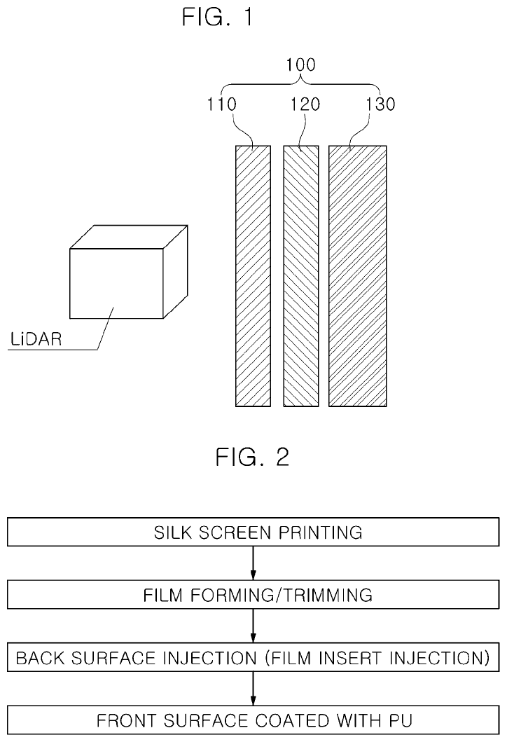

FIG. 1 schematically illustrates an example of a transmission cover for a LiDAR sensor of the present disclosure.

In some implementations, the transmission cover can selectively transmit infrared light having a specific wavelength range and reflect visible light to sense a LiDAR signal.

For example, to implement a function of the transparent cover for a LiDAR sensor and improve the design aspect for integration with the exterior design of a vehicle, a film layer 120 for design implementation is stacked on a base layer 110 made of a thermoplastic polycarbonate (PC) material, and a protective layer 130 is coated on the film layer 120 to protect the film layer 120.

In some implementations, the film layer 120 can include a design pattern or pattern film that can implement a metallic color or a 3D shape or the like.

In some examples, the protective layer 130 can be made of a polyurethane (PU) material and can exhibit self-restoring performance, thereby protecting the cover from external factors such as an impact.

In some cases, in addition to PU, self-restoring materials with a LiDAR transmission performance of 80% or more can be applied to the protective layer 130.

The present disclosure can be applied to, for example, a vehicle grille to optimize a sensor function while harmonizing with the design of the vehicle, and ensure the smooth operation of the LiDAR sensor while improving the exterior design of the vehicle using the film layer 120 of an insert film and urethane.

In some implementations, it can be possible to minimize problems such as gate wash, film creep, folding, and orange peel using the insert film injection process using double injection such as reaction injection molding (RIM), low pressure injection such as injection compression molding (ICM), and vertical injection processes in order to form the film layer 120, and solve problems that may occur during the injection process by adopting a structure that protects the infrared-transmitting metallic film using a PC film.

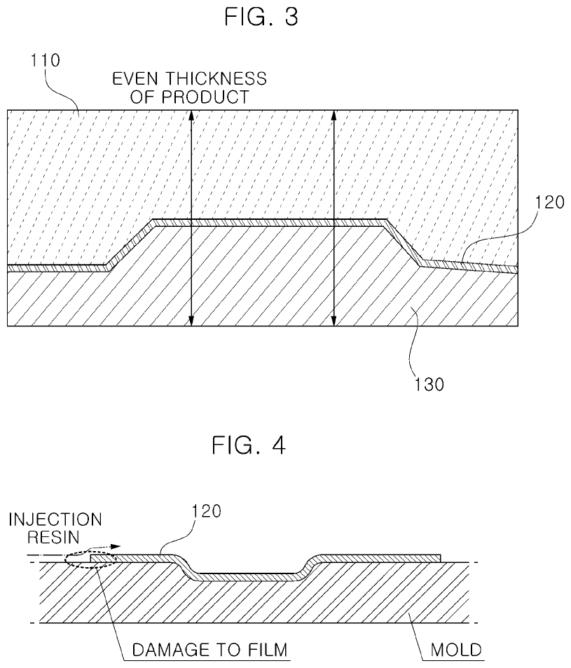

Specifically, the film layer 120 can define a pattern such as a three-dimensional uneven shape as shown in FIG. 3, and the film layer 120, as shown in FIG. 2, can be manufactured by forming/trimming the film using a mold after silk screen printing. In some examples, the transmission cover can have an even thickness while having an uneven shape. The film layer 120 can be trimmed after implementing the three-dimensional shape by a press after preheating. For instance, the three-dimensional can include a protrusion or a recess.

In some implementations, the film is inserted into the mold, and a first injection-molded product in which the film layer 120 is stacked and bonded on the base layer 110 is injected, and the protective layer 130 is coated or injected on the film layer 120 to manufacture the transmission cover 100.

In this case, in the case of the insert injection, film fixation in the mold is important, and products having an uneven shape are more important.

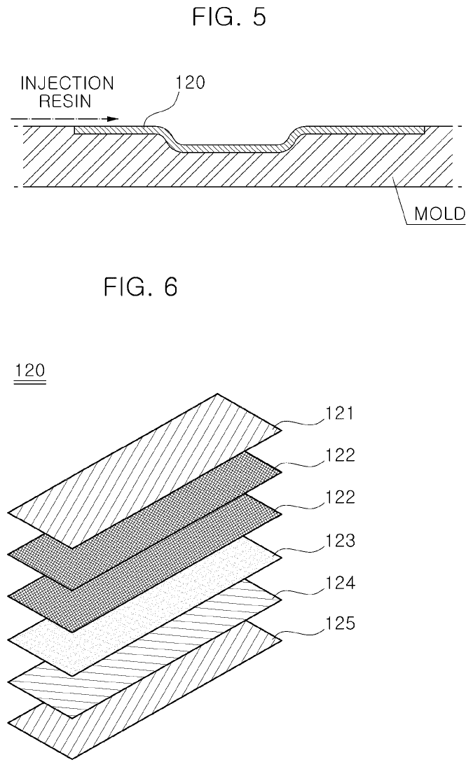

In some implementations, as shown in FIG. 5, the film insert structure is formed so as not to be positioned on an injection resin path. In the case of FIG. 4, the film is positioned on the injection resin path, where an injection resin flow may be interrupted and the film may be damaged. As shown in FIG. 5, the mold can be designed in a structure in which the entire area is completely inserted into the insert part so that the film can be properly fixed in the mold.

The film layer 120 of the present disclosure can implement a metallic color or implement a 3D shape or the like as manufactured as described above, and thus implement a design such as a metallic appearance.

FIGS. 6-11 illustrate examples of a film layer of a transmission cover for a LiDAR sensor according to the present disclosure.

Referring to FIG. 6, the film layer 120 can be formed of a multi-layer as illustrated and includes a LiDAR-transmitting film 124 for LiDAR transmission property that can implement a color such as a metallic appearance on a PC layer 125 as the lowest layer.

In some examples, an infrared (IR) printing layer 122 for implementing a design pattern can be stacked, and a binder layer 123 can be printed for bonding. The binder layer 123 can provide a LiDAR transmission performance of 80% or more. The IR printing layer 122 can be an ink that has a LiDAR transmission performance of 80% or more.

In some implementations, an uppermost layer can be printed with the PC layer 121, and a protective material is applied to the PC layer 121. A protective fabric can be applied to front and back surfaces of the PC layer 121, thereby preventing damage to the IR printing layer 122, the binder layer 123, and the LiDAR-transmitting film 124.

The PC layer 121 is a thermoplastic resin, and polyethylene terephthalate (PET), PC, polyethylene (PE), or the like can be applied.

In some examples, the LiDAR-transmitting film 124 can be a multi-layered film including nano-sized PET films stacked about 1,000 layers and implemented as a metallic film. For instance, each film of the nano-sized PET films can have a preset thickness less than 1 μm.

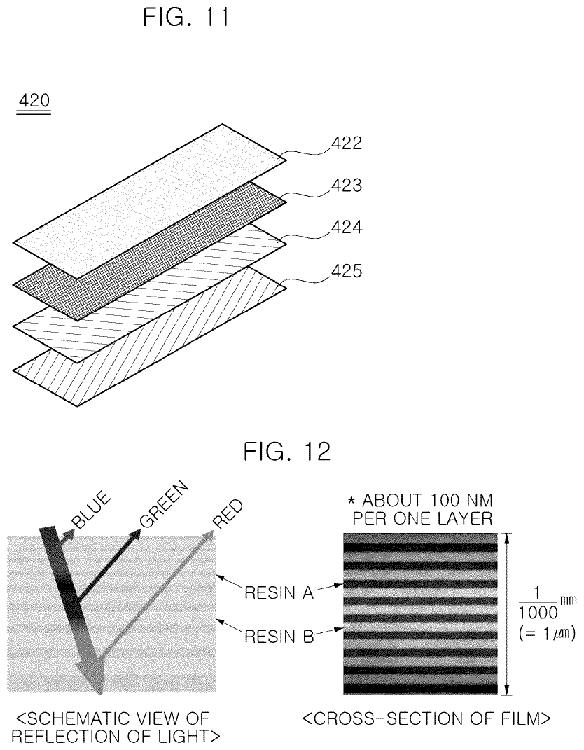

For example, as shown in FIG. 12, by controlling each light wavelength through nano-unit thickness control and stack technology, a metallic exterior can be exhibited without using a metal. That is, light of all colors can be reflected by interference reflection at an interface between resin A and resin B. In some cases, where a film deposited with a metal such as aluminum (Al) and nickel (Ni) is applied, near-infrared transmission may not be possible.

To test the performance influence of the transmission cover for a LiDAR sensor of the present disclosure, the metallic cover of the present disclosure was mounted on the LiDAR and the test was conducted, and the intensity was measured using an 80% reflector (1.0 m×1.0 m) at a distance of 30 m.

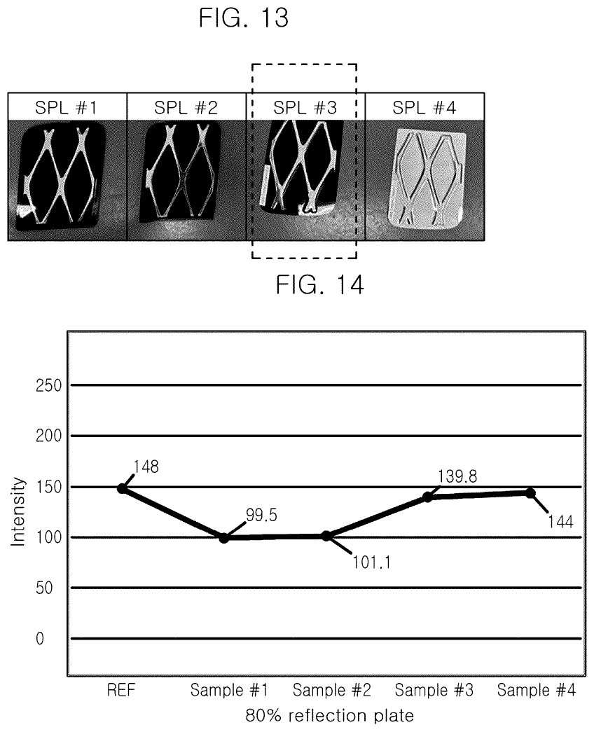

Sample 1 (SPL #1) is a plastic injection double-sided cover, Sample 2 (SPL #2) is a plastic injection single-sided cover, Sample 3 (SPL #3) is a metallic film and an IR printing layer, and Sample 4 (SPL #4) is a metallic film unit, and as shown in FIG. 13, it can be seen that Sample 3 (SPL #3) can implement an overall metallic design. FIG. 14 shows that the intensity of Samples 3 and 4 is greater than that of Samples 1 and 2, enabling object recognition.

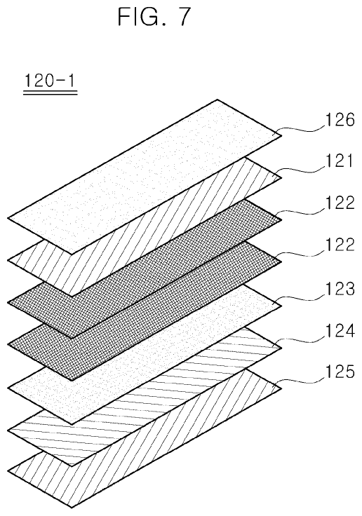

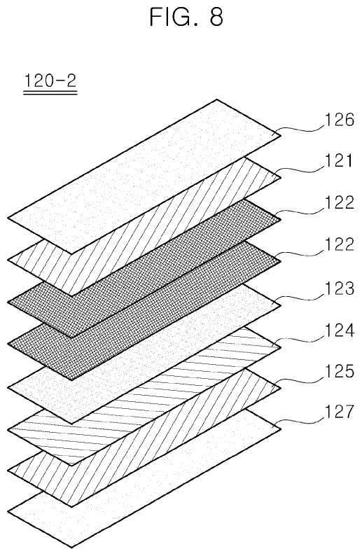

Referring to FIG. 7, a film layer 120-1 can have a binder layer 126 added on a front surface of the PC layer 121. Referring to FIG. 8, a film layer 120-2 can have the binder layer 126 added on a front surface of the PC layer 121 and the binder layer 127 added on a back surface of the PC layer 125.

This can be applied in consideration of bonding with the counterpart.

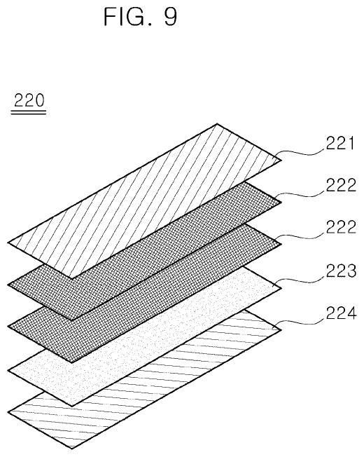

Referring to FIG. 9, in some implementations, a film layer 220 can be composed of the same LiDAR-transmitting film 224, IR printing layer 222, and binder layer 223, and, depending on the type of injection resin, the PC layer 221 can be provided on a front surface of the IR printing layer 222 or a back surface of the LiDAR-transmitting film 224. Therefore, the entire thickness of the film can be adjusted.

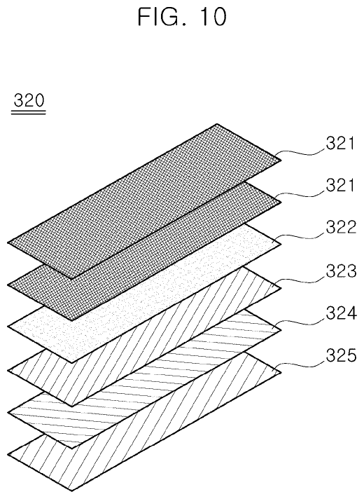

Referring to FIG. 10, in some implementations, a film layer 320 can include the same LiDAR-transmitting film 324, IR printing layer 321, and binder layer 322, and can include a PC layer 323 formed on a front surface of the LiDAR-transmitting film 324 and a PC layer 325 formed on a rear surface of the LiDAR-transmitting film 324.

Referring to FIG. 11, in some implementations, a film layer of a transmission cover for a LiDAR sensor can be implemented as a minimum film printing layer like the film layer 420. For instance, the minimum film layer can include a LiDAR-transmitting film 424, an IR printing layer 423, and a binder layer 422 that are stacked, which perform the same function as those of the example shown in FIGS. 6-10, and include a PC layer 425 formed on a back surface of the LiDAR-transmitting film 424.

The above-described example film layers 120, 220, 320, and 420 in the present disclosure provide LiDAR transmittance performance of 80% or more.

As described above, the transmission cover for a LiDAR sensor of the present disclosure is an integrated transmission cover with a metallic appearance, LiDAR transmittance, and surface self-restoration, can have LiDAR transmission performance, and can be easily implemented in terms of a design.

Although the present disclosure has been described above with reference to the exemplary drawings, the present disclosure is not limited to the described embodiments, and it is apparent to those skilled in the art that various modifications and changes can be made without departing from the spirit and scope of the present disclosure. Therefore, these modified examples or changed examples should be included in the claims of the present disclosure, and the scope of the present disclosure should be construed based on the appended claims.

What is claimed is:

1. A transmission cover for a light detection and ranging (LiDAR) sensor, comprising:
a base layer made of a thermoplastic material; and
a film layer that is bonded to the base layer and provides a metallic color, the film layer comprising a plurality of layers that are stacked.

2. The transmission cover of claim 1, wherein the plurality of layers of the film layer comprise a LiDAR-transmitting film that provides the metallic color and is configured to transmit infrared light having a preset wavelength range.

3. The transmission cover of claim 2, wherein the LiDAR-transmitting film is a multi-layered film comprising polyethylene terephthalate (PET) films that are each thinner than 1 μm.

4. The transmission cover of claim 2, wherein the plurality of layers of the film layer further comprise an infrared (IR) printing layer that is stacked on the LiDAR-transmitting film, the IR printing layer having a preset pattern.

5. The transmission cover of claim 4, wherein the plurality of layers of the film layer further comprise a binder layer that is interposed between the LiDAR-transmitting film and the IR printing layer and couple the LiDAR-transmitting film and the IR printing layer to each other.

6. The transmission cover of claim 4, wherein the plurality of layers of the film layer further comprise a first polycarbonate (PC) layer that is disposed on a surface of the LiDAR-transmitting film.

7. The transmission cover of claim 6, wherein the plurality of layers of the film layer further comprise a second PC layer that is disposed on a surface of the IR printing film.

8. The transmission cover of claim 7, wherein the plurality of layers of the film layer further comprise a binder layer that is disposed on a surface of the first PC layer or a surface of the second PC layer.

9. The transmission cover of claim 4, wherein the plurality of layers of the film layer further comprise a polycarbonate (PC) layer that is disposed on a surface of the IR printing film.

10. The transmission cover of claim 4, wherein the plurality of layers of the film layer further comprise a polycarbonate (PC) layer that is disposed on a surface of the LiDAR-transmitting film.

11. The transmission cover of claim 2, further comprising a protective layer that is made of a polyurethane (PU) material and coated on the film layer.

12. The transmission cover of claim 2, wherein the film layer defines a three-dimensional shape.

13. A transmission cover for a light detection and ranging (LiDAR) sensor, comprising:
a film layer that provides a metallic color and defines a three-dimensional shape having a protrusion or a recess;
a base layer made of a thermoplastic material and attached to a first side of the film layer;
a protective layer made of polyurethane and attached to a second side of the film layer opposite to the first side,
wherein the base layer and the protective layer cover the film layer and have internal shapes corresponding to the three-dimensional shape of the film layer to thereby define an even thickness of the transmission cover.

14. The transmission cover of claim 13, wherein the film layer comprises a plurality of layers comprising:
one or more upper polycarbonate (PC) layers;
one or more infrared (IR) printing layers disposed below and attached to one of the one or more upper PC layers;
a binding layer disposed below and attached to the one or more IR printing layers; and
a LiDAR-transmitting film disposed below and attached to the binding layer.

15. The transmission cover of claim 14, wherein the one or more IR printing layers have a preset pattern, and
wherein the LiDAR-transmitting film is a multi-layered film comprising polyethylene terephthalate (PET) films that are each thinner than 1 μm.

16. The transmission cover of claim 14, wherein the plurality of layers of the film layer further comprise a lower PC layer that is disposed below and attached to the LiDAR-transmitting film, the lower PC layer defining a bottom surface of the film layer.

17. The transmission cover of claim 16, wherein the plurality of layers of the film layer further comprise a top binder layer disposed above and attached to the one or more upper PC layers, the top binder layer defining a top surface of the film layer.

18. The transmission cover of claim 14, wherein the plurality of layers of the film layer further comprise:
a top binder layer disposed above and attached to the one or more upper PC layers, the top binder layer defining a top surface of the film layer;
a lower PC layer that is disposed below and attached to the LiDAR-transmitting film; and
a bottom binder layer disposed below and attached to the lower PC layer, the bottom binder layer defining a bottom surface of the film layer.

19. The transmission cover of claim 13, wherein the film layer comprises a plurality of layers comprising:
a binder layer that defines a top surface of the film layer;
an infrared (IR) printing layer below and attached to the binder layer;
a LiDAR-transmitting film disposed below and attached to the IR printing layer; and
a lower PC layer that is disposed below and attached to the LiDAR-transmitting film, the lower PC layer defining a bottom surface of the film layer.

20. The transmission cover of claim 19, wherein the one or more IR printing layers have a preset pattern, and
wherein the LiDAR-transmitting film is a multi-layered film comprising polyethylene terephthalate (PET) films that are each thinner than 1 μm.
